(19) United States
(12) Patent Application Publication
(10) Pub. No.: US 2012/0260662 A1
(43) Pub. Date: Oct. 18, 2012

(54) RADIATION SHIELD FOR A GAS TURBINE COMBUSTOR

(75) Inventors: James S. Nash, North Hampton, NH (US); Alex Moerlein, Salem, MA (US)

(73) Assignee: ICR Turbine Engine Corporation, Hampton, NH (US)

(21) Appl. No.: 13/372,998

(22) Filed: Feb. 14, 2012

Related U.S. Application Data
(60) Provisional application No. 61/442,647, filed on Feb. 14, 2011.

(51) Int. Cl. F02C 7/24; F02C 7/10

(52) U.S. Cl. 60/772; 60/39.511

(57) ABSTRACT

A method is disclosed for directing flow to a combustor embedded in a recuperator while shielding the recuperator from radiative heat transfer from the combustor. The radiation heat shield also serves as a structural component to center the combustor within the recuperator core cavity and to allow motion between the combustor and recuperator as temperatures vary. The disclosure is illustrated by the example a gas turbine engine comprising three turbomachinery spools, an intercooler, a recuperator and a combustor. Thermal efficiency of such an engine can be increased by raising the high pressure turbine inlet temperature. It is a specific goal of the present disclosure to reduce radiative heating of a recuperator by a combustor which is housed substantially inside the recuperator.

### CROSS REFERENCE TO RELATED APPLICATION

The present application claims the benefits, under 35 U.S.C. §119(e), of U.S. Provisional Application Ser. No. 61/442,647 entitled “Radiation Shield for a Gas Turbine Combustor” filed on Feb. 14, 2011, which is incorporated herein by reference.

### FIELD

The present disclosure relates generally to gas turbine engine systems and specifically to a method for directing pre-combustion gas flow to a combustor embedded in a recuperator while shielding the recuperator from radiative heat transfer from the combustor.

### BACKGROUND

There is a growing requirement for alternate fuels for vehicle propulsion and power generation. These include fuels such as natural gas, bio-diesel, ethanol, butanol, hydrogen and the like. Means of utilizing various fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion and power generation. Gas turbine engines have the advantage of being highly fuel flexible and fuel tolerant. Additionally, these engines burn fuel at a lower temperature than reciprocating engines so produce substantially less NOx per mass of fuel burned.

The efficiency and specific power of gas turbine engines can be improved and engine size can be further reduced by increasing the pressure and temperature developed at the exit of the combustor while still remaining well below the temperature threshold of significant NOx production in the combustor reaction zone. This can be done using conventional metallic combustor to extract energy from the fuel. As combustor exit temperature and pressure are raised, new requirements are generated in other components such as the recuperator and compressor-turbine spools.

There remains a need for new design approaches and new materials for operating at ever increasing combustor outlet temperatures and pressures in gas turbine engines so as to improve efficiency and reduce engine size while maintaining very low levels of NOx production.

### SUMMARY

These and other needs are addressed by the various embodiments and configurations of the present disclosure which are directed generally to gas turbine engine systems and specifically to a method for directing pre-combustion flow (typically air but, in some cases, an air-fuel mixture) to a combustor embedded in a recuperator while shielding the recuperator from radiative heat transfer from the combustor. The radiation heat shield also serves as a structural component to center the combustor within the recuperator core cavity and to allow motion between the combustor and recuperator as temperatures vary.

The following definitions are used herein:

The Arrhenius equation is a well-known relationship for the temperature dependence of the reaction rate constant, and therefore, rate of a chemical reaction. The reaction rate constant, k, is given by:

k=A exp(−Eₐ/(RT))

where A is a constant, Eₐ is the activation energy, R is the gas constant and T is the absolute temperature.

An energy storage system refers to any apparatus that acquires, stores and distributes mechanical or electrical energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines.

A free power turbine as used herein is a turbine which is driven by a gas flow and whose rotary power is the principal mechanical output power shaft. A free power turbine is not connected to a compressor in the gasifier section, although the free power turbine may be in the gasifier section of the gas turbine engine. A power turbine may also be connected to a compressor in the gasifier section in addition to providing rotary power to an output power shaft.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A gasifier is a turbine-driven compressor in a gas turbine engine dedicated to compressing air that, once heated, is expanded through a free power turbine to produce

A prime power source refers to any device that uses energy to develop mechanical or electrical power, such as motion in some other machine. Examples are diesel engines, gas turbine engines, microturbines, Stirling engines, spark ignition engines and fuel cells.

A heat exchanger is a device that allows heat energy from a hotter fluid to be transferred to a cooler fluid without the hotter fluid and cooler fluid coming in contact. The two fluids are typically separated from each other by a solid materia, such as a metal, that has a high thermal conductivity.

A power control apparatus refers to an electrical apparatus that regulates, modulates or modifies AC or DC electrical power. Examples are an inverter, a chopper circuit, a boost circuit, a buck circuit or a buck/boost circuit.

Power density as used herein is power per unit volume (watts per cubic meter).

A recuperator is a heat exchanger dedicated to returning exhaust heat energy from a process back into the process to increase process efficiency. In a gas turbine thermodynamic cycle, heat energy is transferred from the turbine discharge to the combustor inlet gas stream, thereby reducing heating required by fuel to achieve a requisite firing temperature.

Regenerative braking is the same as dynamic braking except the electrical energy generated is captured in an energy storage system for future use.

Specific power as used herein is power per unit mass (watts per kilogram).

Spool refers to a group of turbo machinery components on a common shaft.

A thermal energy storage module is a device that includes either a metallic heat storage element or a ceramic heat storage element with embedded electrically conductive wires. A thermal energy storage module is similar to a heat storage block but is typically smaller in size and energy storage capacity.

A turbine is a rotary machine in which mechanical work is continuously extracted from a moving fluid by expanding the fluid from a higher pressure to a lower pressure. The simplest turbines have one moving part, a rotor assembly, which is a shaft or drum with blades attached. Moving fluid acts on the blades, or the blades react to the flow, so that they move and impart rotational energy to the rotor.

Turbine Inlet Temperature (TIT) as used herein refers to the gas temperature at the outlet of the combustor which is closely connected to the inlet of the high pressure turbine and these are generally taken to be the same temperature.

A turbo-compressor spool assembly as used herein refers to an assembly typically comprised of an outer case, a radial compressor, a radial turbine wherein the radial compressor and radial turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention. In the drawings, like reference numerals refer to like or analogous components throughout the several views.

FIG. 1 is a graph of NOx production versus combustion flame temperature.

FIGS. 2a-c are schematics of prior art combustor types.

FIG. 3 is an isometric schematic view of a prior art heat exchanger.

FIGS. 4a-b are schematic views of prior art heat exchangers.

FIG. 5 is a top view showing the gas flow pattern through the hot side of a recuperator designed for an embedded combustor.

FIG. 6 is a front view showing the gas flow pattern through the cold side of a recuperator designed for an embedded combustor.

FIG. 7 is a schematic of a combustor embedded in a recuperator with a radiation shield.

FIG. 8 is a close-up view of the gas flow pattern around a radiation shield.

FIG. 9 illustrates the radiant flux from a high-performance combustor.

FIG. 10 is a schematic of a combustor embedded in a recuperator with a radiation shield.

### DETAILED DESCRIPTION

### Baseline Gas Turbine Engine Performance

A preferable engine type is a high-efficiency gas turbine engine because it typically has lower NOx emissions, is more fuel flexible and has lower operating costs. For example, an intercooled recuperated gas turbine engine in the range of about 10 kW to about 1,000 kW is feasible with thermal efficiencies above about 40%. A gas turbine engine generates lower NOx emissions because it combusts its fuel at a constant temperature compared to a reciprocating engine of the same power which combusts its fuel episodically at higher peak temperatures for short durations.

A potential gas turbine engine used for large vehicles is in the output power range of about 250 kW to about 500 kW. These engines operate with high pressure turbine inlet temperatures in the range of about 1,280K to about 1,400K and with full power pressure ratios in the range of about 8 to about 18. Peak engine thermal efficiencies for these engines are in the range of about 35% to about 45% (shaft output power to rate of fuel energy consumption). An engine embodying this design is described, for example, in U.S. patent application Ser. No. 12/115,134 filed May 5, 2008, entitled “Multi-Spool Intercooled Recuperated Gas Turbine”, which is incorporated herein by this reference.

In the present disclosure, the example is used of a gas turbine engine comprising three turbomachinery spools, an intercooler, a recuperator and a combustor. The 3 spools are a low pressure spool, a high pressure spool and a free, power turbine spool.

Gas, typically air, is ingested into a low pressure compressor whose outlet passes through an intercooler which removes a portion of heat from the gas stream at approximately constant pressure. The gas then enters a high pressure compressor. The outlet of high pressure compressor passes through a recuperator where some heat from the exhaust gas is transferred, at approximately constant pressure, to the gas flow from the high pressure compressor. The further heated gas from the recuperator is then directed to a combustor where a fuel is burned, adding heat energy to the gas flow at approximately constant pressure. The gas, commonly called combustion products, emerging from the combustor then enters a high pressure turbine where work is done by the turbine to operate the high pressure compressor. The gas from the high pressure turbine then drives a low pressure turbine where work is done by the turbine to operate the low pressure compressor. The gas from the low pressure turbine then drives a free power turbine. The shaft of the free power turbine, in turn, drives a transmission which may be an electrical, mechanical or hybrid transmission for a vehicle. Alternately, the shaft of the free power turbine can drive an electrical generator or alternator.

As can be appreciated, this basic engine architecture can be modified by adding reheaters either after the high pressure turbine or after the low pressure turbine or both and by adding additional turbo-compressor spools and intercooling apparatuses. Such engine architecture is described, for example, in U.S. Provisional Application No. 61/501,552, filed Jun. 27, 2011 entitled “Advanced Cycle Gas Turbine Engine” which is incorporated herein by reference. The basic engine architecture can also be modified by adding thermal energy storage devices within the pressure boundary of the engine. Such additions are described in U.S. patent application Ser. No. 12/777,916 filed May 11, 2010 entitled “Gas Turbine Energy Storage and Conversion System”, which is incorporated herein by reference. The basic engine architecture can be further modified by adding motor/generators to one of more of the turbo-compressor spools such as described in U.S. patent application Ser. No. 13/175,564 filed Jul. 1, 2011, entitled “Improved Multi-spool Intercooled Recuperated Gas Turbine”, which is incorporated herein by reference.

The gas turbine engines described herein typically comprise at least one major component either fabricated from a ceramic material such as alumina, silicon carbide, silicon nitride and the like. Major components that may be fabricated from ceramic materials include, for example, the combustor, any reheaters and any of the turbine rotors, rotor shrouds and volutes. If ceramic components are not used, the engine may be comprised of actively cooled metallic components such as described in U.S. Provisional Patent Application 61/596,563 entitled “Active Cooling System for a Radial In-Flow Turbine” filed Feb. 8, 2012, which is incorporated herein by reference.

A baseline intercooled, recuperated, multi-spool gas turbine engine operating on methane fuel is used to illustrate the engine efficiency and output power. As an example, consider the performance of an intercooled and recuperated gas turbine. With reference to Table I, the computed baseline engine inputs and outputs at full power are as follows:

TABLE I

| Fuel | Methane |
|---|---|
| Shaft Power Out at Full Power (kW) | 377 |
| Thermal Efficiency (%) | 43.18 |
| Turbine Inlet Temperature (K) | 1,366 |
| Turbine Inlet Pressure (Pa) | 1,412,088 |
| Inlet Air Flow Rate (kg/s) | 1.172 |
| Fuel-Air Ratio | 0.0149 |
| Fuel Flow Rate (kg/s) | 0.01746 |

The computed pressures and temperatures at full power are shown in Table II for various locations in the thermodynamic cycle.

TABLE II

| | p (Pa) | T (K) |
|---|---|---|
| Ambient Air In | 101,379 | 288.15 |
| Output Low Pressure Compressor | 302,552 | 424.5 |
| Output Intercooler | 296,501 | 292.0 |
| Output High Pressure Compressor | 1,482,414 | 500.1 |
| Output Recuperator Cold Side | 1,452,766 | 779.2 |
| Output Combustor | 1,412,088 | 1,366.5 |
| Output High Pressure Turbine | 702,408 | 1,194.6 |
| Output Low Pressure Turbine | 427,134 | 1,080.4 |
| Output Free Power Turbine | 104,739 | 809.9 |
| Output Recuperator Hot Side | 101,886 | 546.4 |
| Exhaust Gases Out | 101,379 | 546.4 |

The above data is computed for methane fuel injected at ambient temperature (˜298 K).

Achieving Higher Thermodynamic Efficiencies with Low Emissions

Thermal efficiency can be increased by raising the high pressure turbine inlet temperature and overall engine pressure ratio but this requires material and design upgrades to other components such as, for example, the recuperator, combustor and high pressure turbine assembly.

It is a specific goal of the present disclosure to reduce radiative heating of a recuperator by a combustor which is housed substantially inside the recuperator. Achieving this goal is part of an overall strategy to increase engine thermal efficiency, reduce engine volume both without significantly increasing NOx emissions.

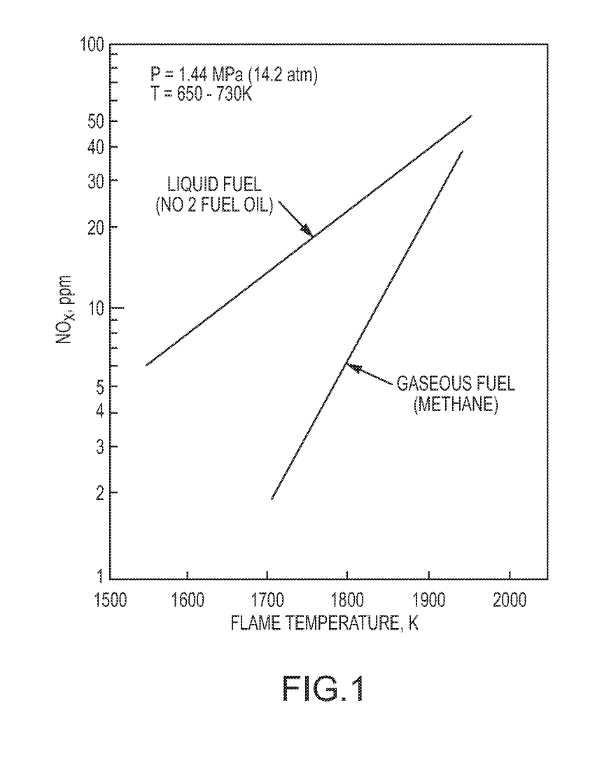

FIG. 1 is a graph of approximate NOx production versus combustion flame temperature. NOx production generally follows the Arrhenius reaction rate law. As can be seen, NOx emissions do not form in significant amounts until flame temperatures reach about 1,800 K. Once this approximate threshold is passed, any further rise in temperature causes a rapid increase in the rate of NOx formation. NOx production is highest at fuel-to-air combustion ratios of 5 to 7% oxygen (25 to 45% excess air). Lower excess air levels starve the reaction for oxygen and higher excess levels drive down the flame temperature, slowing the rate of reaction.

Current EPA standards for engines in the range of about 100 kW or above is 0.27 g/kW-hr. Diesels can achieve this NOx emissions standard by a number of strategies but each accrues a cost in terms of power plant weight, power plant efficiency and/or complexity. Gas turbine engines in the range of about 250 kW to about 500 kW and operating at peak combustion temperatures of about 1,370 K produce about 0.05 g/kW-hr of NOx. It is clear that the thermal efficiency of gas turbine engines such as described above can be increased by increasing peak combustor temperature (also known as turbine inlet temperature when the combusted gas is sent directly to a turbine) without increasing NOx to levels that would exceed current and near-future EPA standards.

Further, gas turbine combustor designs are being improved to reduce or eliminate temperature excursions above average combustion temperatures. These excursions above average combustion temperatures will increase NOx production and their elimination will minimize NOx production.

### Prior Art Combustors and Recuperators

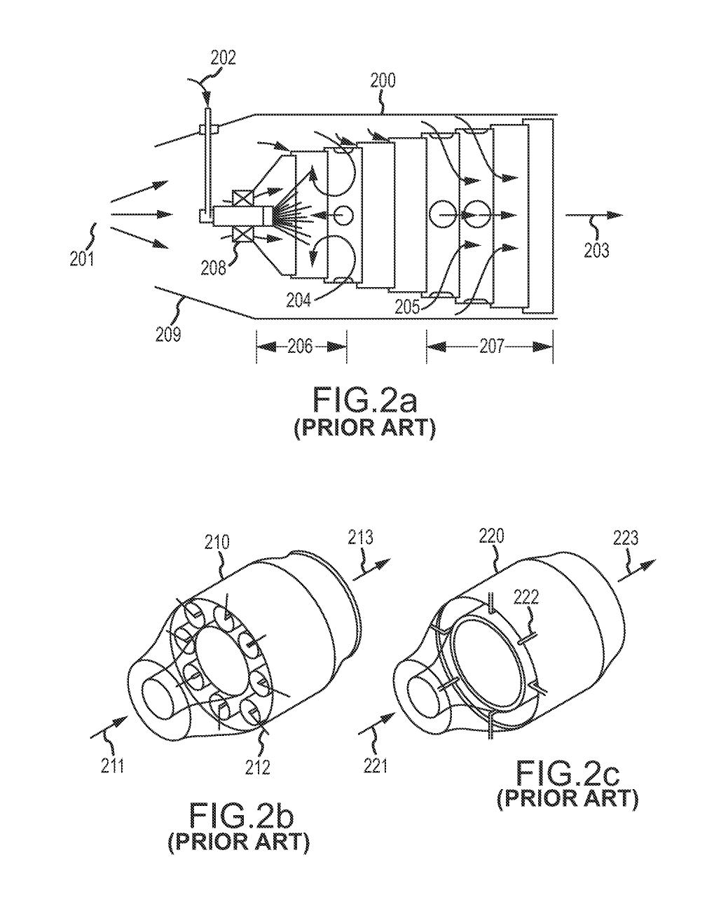

FIG. 2 is a schematic of prior art combustor types. FIG. 2a shows a conventional metallic can-type combustor 200 with a single large combustion chamber. Incoming air 201 is divided into two portions. A first portion enters a swirler head 208 which mixes the air with fuel 202. Combustion takes place in the inner chamber which is designed to combust a fully mixed fuel-air mixture of the proper proportions, formed, in the pre-chamber or primary zone 206. The other portion of air flows around the inner chamber and enters ports to cool the combustion chamber (arrows 204) and to dilute the combustion products (arrows 205). The dilution air flow 205 is typically introduced into the fully combusted gases in the downstream end of the combustor in the secondary dilution zone 207. The fully combusted and diluted combustion products 203 are then delivered, in the present example engine, to a high pressure turbine. The goal of this type of combustor design is to produce the most homogeneous combustion possible. That is, to reduce or eliminate temperature excursions above and below the average desired combustion temperature.

FIG. 2b illustrates a cannular configuration 210 which is comprised of several combustion chambers (also known as burner or flame tubes) each supplied with a portion of incoming air 211 and individual fuel supplies 212. The fully diluted combustion products 213 are then delivered to a turbine.

FIG. 2c illustrates an annular configuration 220 which is comprised of an annular combustion chamber with distributed fuel injectors 222. The portion of air used for dilution flows down the center passage. The fully diluted combustion products 223 are then delivered to a turbine.

In all of these configurations, the primary air flow and the fuel are introduced together to deliver a fully mixed fuel-air mixture of the proper proportions to produce a gas mixture suitable for homogeneous combustion. The dilution air flow is typically introduced into the fully combusted gases in the downstream end of the combustor. In all three combustor configurations, the fuel and air typically enter the inlet end of the combustor (left side of FIG. 2) and the diluted combustion products exit the outlet end of the combustor (right side of FIG. 2). FIG. 2 is taken from “The Design of High-Efficiency Turbomachinery and Gas Turbines”, D. G. Wilson and T. Korakianitis, Prentice Hall, Inc. 1998.

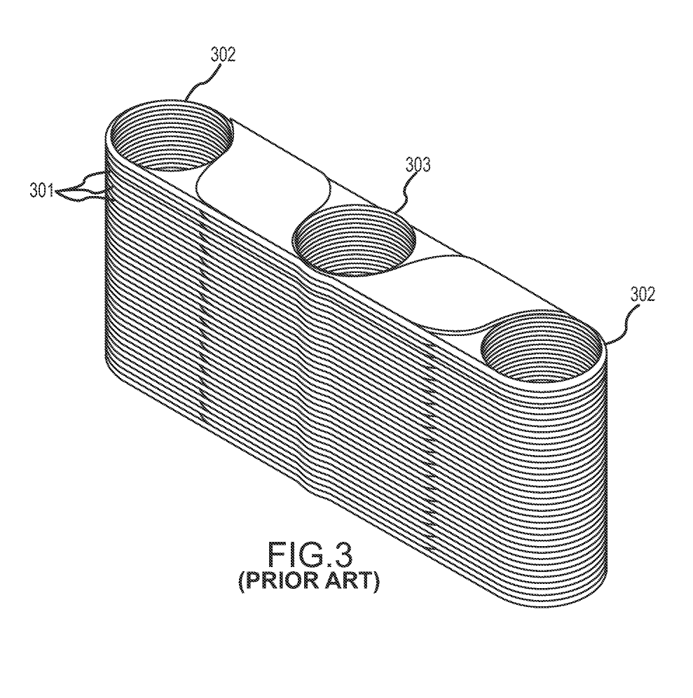

FIG. 3 is an isometric schematic view of a prior art recuperator. This heat exchanger was disclosed in U.S. patent application Ser. No. 12/115,219 entitled “Heat Exchanger with Pressure and Thermal Strain Management”, filed May 5, 2008. This design is a three-manifold, dual-matrix counter-flow plate-fin heat exchanger, whose design allows free growth of a hot center manifold supported by tensile structures at cold ends. This heat exchange device includes a plurality of heat exchange cells in a stacked configuration 301 arranged around two outer manifolds 302 and an intermediate manifold 303 which, in this example, is shown centered between the two outside manifolds 302. Each of the manifolds has a closed end and an open end opposite the closed end. The heat exchange core may be comprised of any number of cells, for example, ranging from two to several hundred or more.

In this design, the cold side gas enters the bottom of the outside manifolds 302 and flows inward to the center manifold 303. The hot side gas flows into one side of the heat exchanger and is turned to flow counter to the cold side gas and is then turned again to flow outward from the opposite side of the heat exchanger.

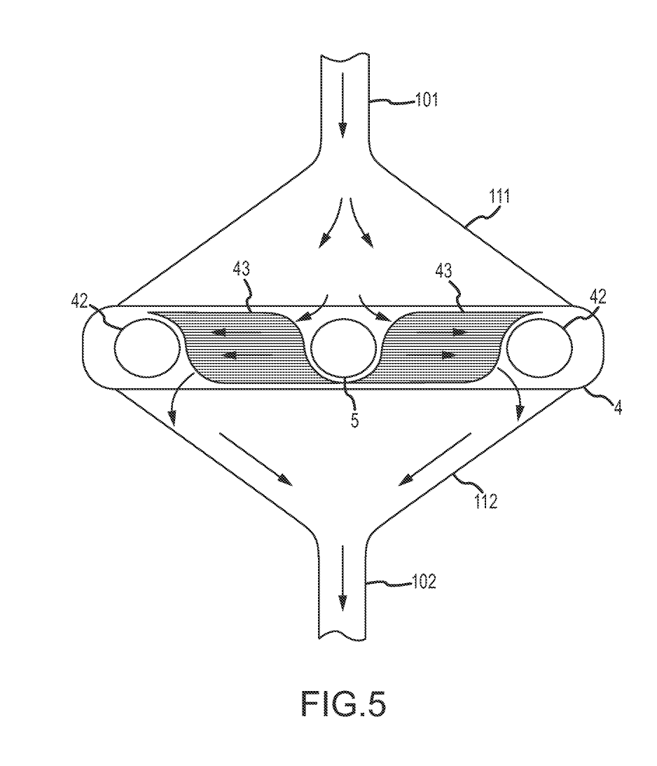

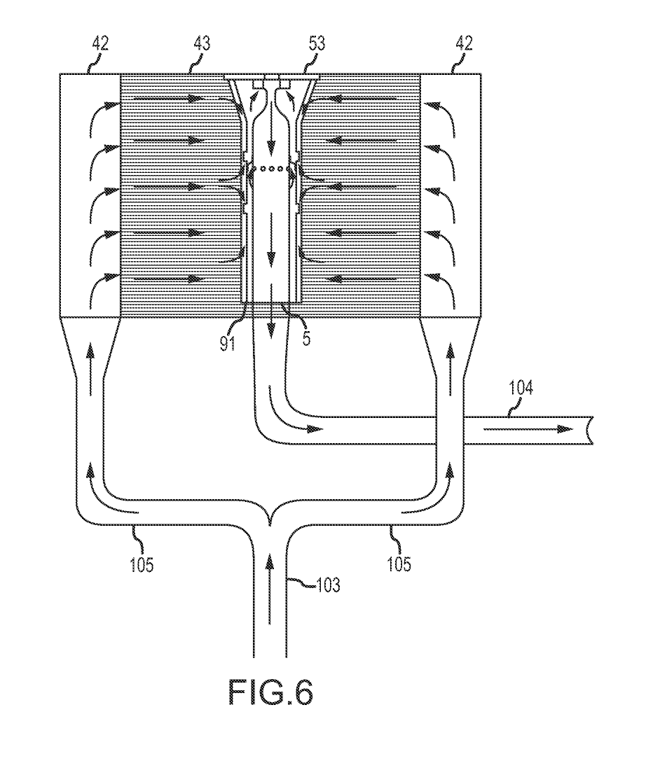

It is possible to position a combustor in the center manifold to conserve space in the combustor-recuperator assembly. The technique of embedding the combustor inside a recuperator is not new. As can be seen, the combustor will be in close proximity to the recuperator and therefore protecting the recuperator from the radiated heat from the combustor will be an important design consideration, especially if it is desired to increase the pressure and temperature of the combustion process so as to increase overall engine thermal efficiency. The operation of this recuperator design is discussed in detail in FIGS. 5 and 6. When a combustor is inserted into an appropriate manifold of a recuperator, this manifold is sometimes referred to as the recuperator core.

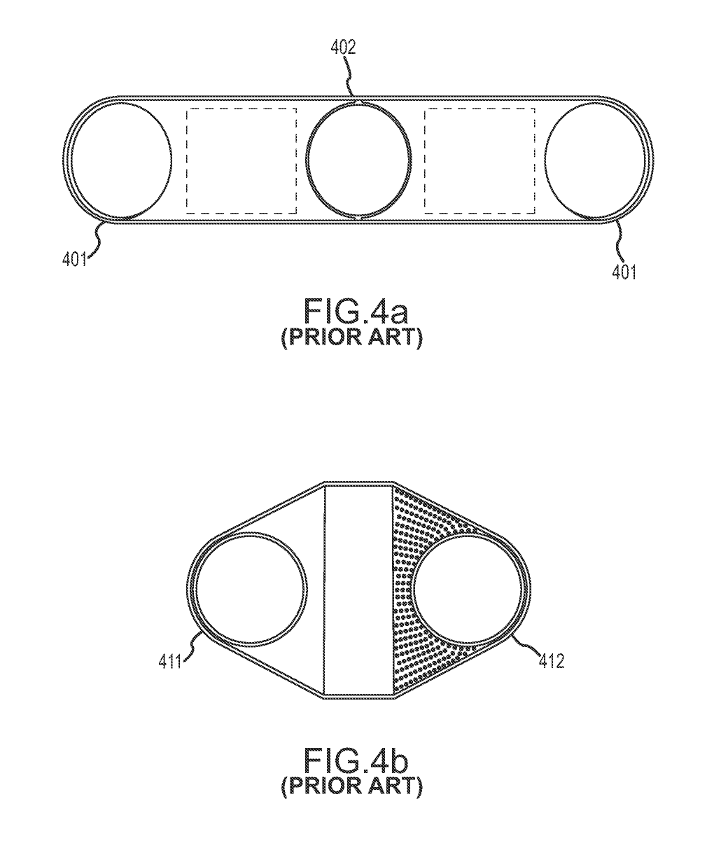

FIG. 4 is a schematic view of prior art recuperators. FIG. 4a illustrates the heat exchanger of FIG. 3 in which the cold side gas enters the bottom of the outside manifolds 401 and flows inward to the center manifold 402. FIG. 4b illustrates a heat exchanger with two manifolds 411 and 412. This design is disclosed in U.S. patent application Ser. No. 12/115,069 entitled “Heat Exchange Device and Method for Manufacture”, filed May 5, 2008. Either heat exchanger configuration can be adapted as a recuperator for a gas turbine engine, and both can be adapted to allow the main combustor to be embedded in the manifold which has cold side air flowing into the combustor along the length of the combustor. In the case of the 3 manifold design of FIG. 4a, the flow of cold side and hot side recuperator gases is illustrated in FIGS. 5 and 6 for a combustor embedded in the center manifold. In the case of the 2 manifold design of FIG. 4b, the flow of cold side and hot side recuperator gases is similar to that illustrated in FIGS. 5 and 6 but flow only from one side.

Achieving High Temperatures with a Combustor Embedded in a Recuperator

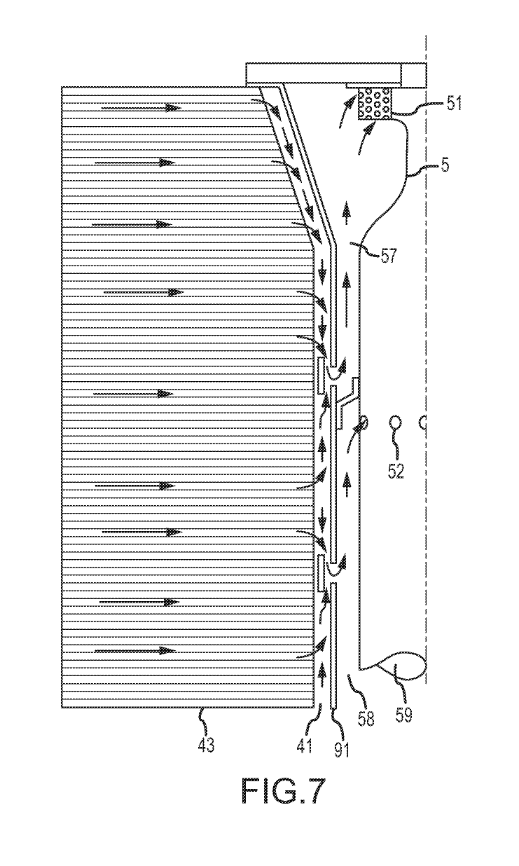

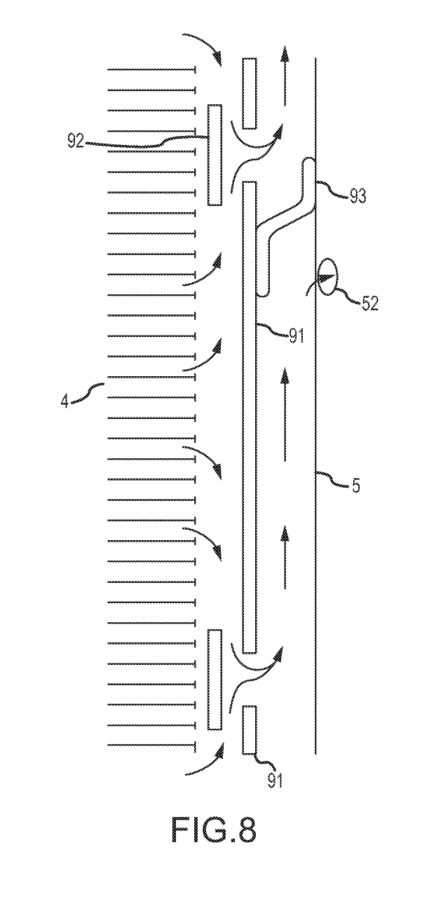

FIG. 5 is a top view showing the gas flow pattern through the hot side of a recuperator such as described in FIG. 3 and which has been modified for an embedded combustor. This figure depicts the flow of hot exhaust gases from the free power turbine which enter via duct 101 and flow through the hot side of recuperator 4, flowing from the center through matrices 43 and then emerging on the periphery and then flowing via duct 102 which guides the de-energized exhaust gases to the exhaust exit. As will be discussed in FIGS. 7 and 8, the cold side flow comes in via manifold ducts 42 and exit via the combustor which fits in center manifold cavity 5. The cold side flow, as shown in FIG. 5, flows in the opposite direction from the hot side flow of FIG. 6 and so this is a counter-flow recuperator. Shroud 111 contains and guides the flow from the free power turbine to the recuperator matrices 43. Shroud 112 contains and guides the flow from the recuperator to the exhaust exit. As can be appreciated, the combustor which is set into cavity 5 is in close proximity to the recuperator mesh matrices. The radiant heat from the combustor can be sufficiently high enough to weaken the braising that is used to construct the recuperator. It is noted that the recuperator pressure differential across the hot and cold sides can be in the range of about 10 to about 15 bars and so the pressure integrity of the recuperator would be compromised if the radiant heat from the combustor weakens or melts the brazed materials within the recuperator.

FIG. 6 is a front view showing the gas flow pattern through the cold side of a recuperator designed for an embedded combustor. This figure depicts the flow of cold side air or air-fuel mixture from the high pressure compressor which enters via duct 103. The flow is split and half flows via duct 105 into recuperator manifold 42 while the other half flows to the opposite side. The flow then is directed through the cold side recuperator matrices 43 and into the center cavity in which the combustor is located. A first portion of the flow (typically about 60% of the incoming flow) is directed to the top of the combustor 5 where it is mixed in a swirler head with fuel and burned. A second portion of the flow (typically about 40% of the incoming flow) is directed to approximately the center of the combustor 5 where it enters dilution holes whereupon it is mixed with the combusted air-fuel to form the final mixture that exits the combustor. The flow exiting the combustor is directed via duct 104 to the inlet of the high pressure turbine. The recuperator is protected from the radiant heat emitted by the combustor liner by a radiation shield 91 which is illustrated in more detail in FIG. 7. The heat shield also increases air flow velocity adjacent to the liner thereby enhancing cooling by increasing the convective heat transfer coefficient.

FIG. 7 is a more detailed schematic of a combustor embedded in a recuperator with a radiation shield showing the flow patterns of gas exiting the recuperator and entering the combustor. The top of the combustor is taken to be were the air and fuel enter the swirler head 51. The bottom of the combustor is taken to be where the combustion products exit the combustor.

The gas exiting the recuperator enters the manifold containing the combustor all along the length of the combustor. The radiation shield serves several functions. First, it directs a first portion of the flow to the swirler head and combustion liner cooling holes and a second portion of the flow to the dilution ports; second, it shields the recuperator core matrices from radiant heat emitted by the combustor outer liner; and third it forms a structure that helps position and secure the combustor inside the recuperator cavity. Cold side flow through the recuperator core matrix 43 emerges all along the outer annulus 41 of the center cavity or core of the recuperator. The lower portions of the flow are directed as shown by flow arrows through the radiation shield 91 to an inner annulus 58 where the flow enters dilution ports 52. The upper portions of the flow are directed as shown by flow arrows through the radiation shield 91 to an inner annulus 57 where the flow enters swirler head 51 where it mixes with fuel and is combusted. As noted in FIG. 2, some of this air is diverted into combustor liner cooling holes which cool the liner of combustor 5. The ports connecting the outer annulus 41 with the inner annuluses 57 and 58 have inlet radiation shield features which block line-of-sight radiation emitted by the combustor.

The combustor illustrated in FIG. 7 is a prior art metallic combustor design, sized for a gas turbine engine with an output shaft power in the range of about 200 kW to about 500 kW. The dilution holes 52 in the combustor are typically in the range of about 5% to about 20% of combustor main body diameter (the main combustor body diameter at the location of the dilution holes). The cooling holes (not shown) in the combustor are typically in the range of about 0.5% to about 2% of combustor main, body diameter. The cooling and dilution holes may be circular, oval, rectangular or slotted. The number and size of these holes are designed to be large enough and/or numerous enough to minimize pressure drop to less than about 3% across the entire combustor.

Radiation shield 91 is designed such that there is no direct line-of sight between the combustor and the recuperator core. The radiation port shields (item 98 in FIG. 8) are sized such that no direct line-of sight exists between the combustor and recuperator core. The only escaping radiation is constrained to reflect off at least one surface before entering the outer annular passages. The radiation shield ports may also be circular, oval, rectangular, or slotted and are designed to be large and/or numerous enough to minimize pressure drop without structurally compromising the shield.

The annular passages between the radiation shield and combustor and between the radiation shield and recuperator core are sized to minimize flow velocities, ideally below about 30 m/s in order to minimize pressure drop. The upper portions of the flow are directed through a first set of radiation shield ports to an inner annulus where the air flow is directed to a swirler head where it mixes with fuel and is combusted. The lower portions of the air flow are directed through a second set of radiation shield ports to a section of the inner annulus where the flow is directed to the main dilution holes. If circular, the first and second set of radiation ports have a diameter that is in the range of about 15% to about 30% of the combustor main body diameter.

The outer annular width is typically less than the inner annular width so that flow cross-sectional area is about the same for both inner and outer annular widths. However, for designs where the outer annular gap is small compared to the combustor body diameter (typical of a stable, low-emissions combustor and a reasonably-sized recuperator), the annular widths may be approximately the same. Typically, the combustor to radiation shield annular width is about 10% to about 20% of combustor body diameter. Typically, the radiation shield to recuperator core annular width is about 5% to about 15% of combustor body diameter.

The materials from which the radiation shield may be made include most high temperature steel alloys such those typically used in the combustor. These include, for example, any of several Hastelloy alloys, high-nickel super-alloys, inconel, monel, maraging steels and alloy steels such as 4130, 4340, and the like. In general, the material of the radiation shield needs to be stable at high-temperature stability and be capable of being easily formed and welded. A typical temperature operating range for the radiation shield is in the range of about 900 K to about 1,100K.

The surfaces of the radiation shield are preferably rough so as to promote turbulent boundary layer flow. For laminar flows, the heat transfer coefficient is low compared to the heat transfer coefficient turbulent flows, because turbulent flow has a thinner stagnant fluid film layer on the heat transfer surface. For the size range of combustors illustrated in the present disclosure, a shield surface roughness in the range of about a 750 RMS surface finish to about a 500 RMS surface finish should be sufficient to promote rapid transition from laminar to turbulent flow. It is also possible to fabricate dimples or other small surface features or roughness to promote turbulent boundary layer heat transfer so that heat energy can be more efficiently wiped away from the hot surfaces of the radiation shield.

FIG. 8 is a close-up view of the gas flow pattern around a radiation shield. This figure illustrates in more detail the inlet radiation shield features 92 which block line-of-sight radiation emitted by the combustor. This view also shows the flow diverter 93 which also assists in centering the combustor 5 within the radiation shield 91.

In the case of a 2 manifold recuperator such as illustrated in FIG. 4b, The cold side gases flow in along one side of the combustor manifold, flow out around the radiation shield and enter the liner cooling ports and dilution ports much the same as in the 3 manifold configuration.

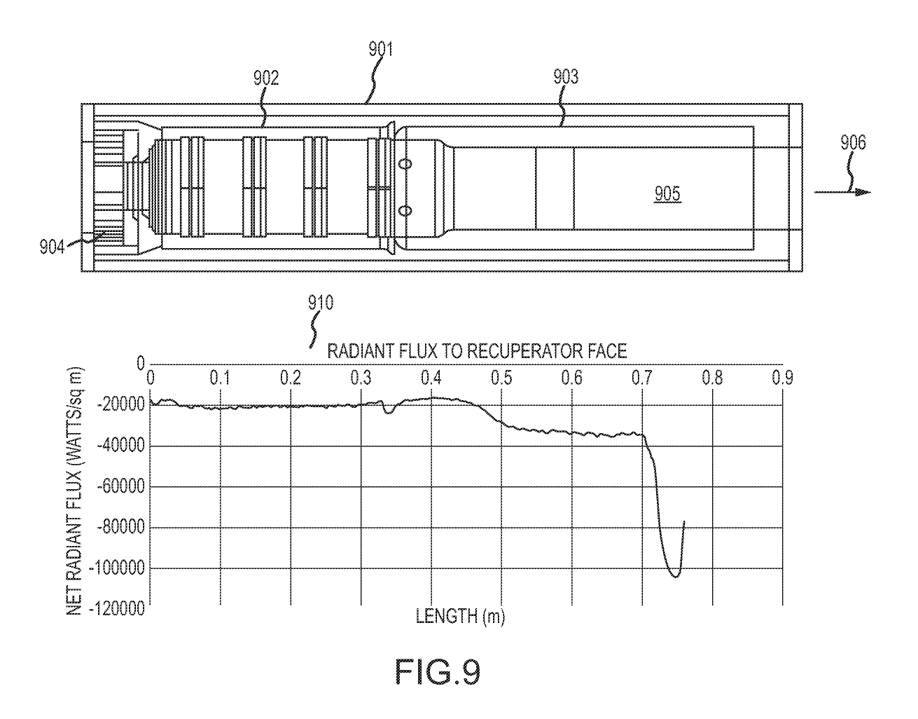

FIG. 9 illustrates a radiant flux calculation from a high-performance combustor to a radiation shield and then to the inside of a recuperator. In this example, the combustion temperature is taken to be about 1,366 K and the liner of the combustion can is also taken to be about 1,366 K. The radiation shield absorbs radiant energy from the combustor and much of this is wiped away by air flow convecting heat away into either the swirler head, into the cooling air holes for the liner or the dilution holes. As a result the outer surface of the radiation shield is stabilized at about 820 K around the primary combustion zone and about 915 K around the secondary dilution zone. The radiant flux to the recuperator surface is about 20,000 watts per square meter over most of the upper surface and increases to about 30,000 watts per square meter over the lower surface. The maximum temperature reached on the interior recuperator surface is about 865 K.

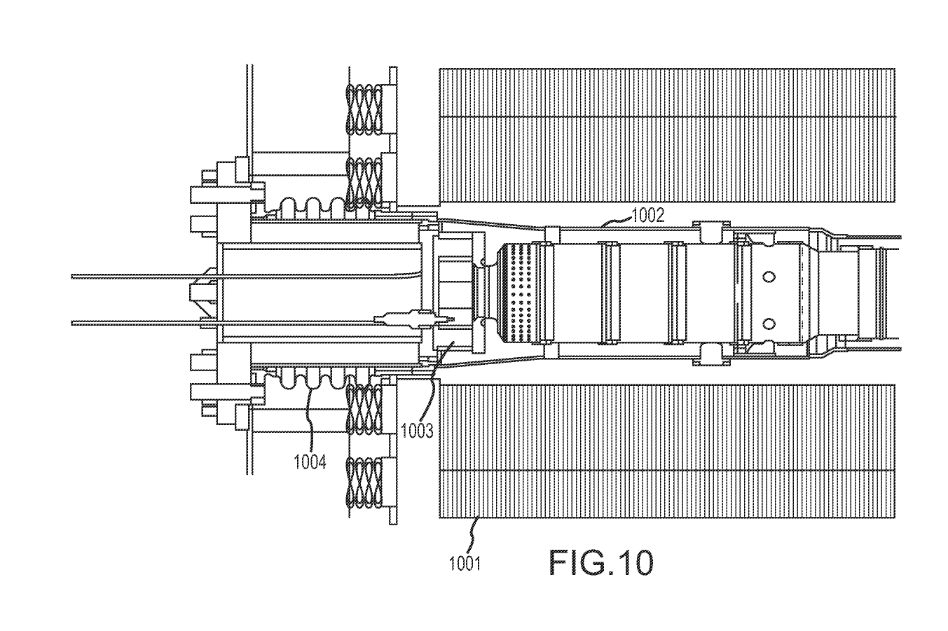

FIG. 10 is a schematic cross-section of the inlet end of a combustor embedded in a recuperator 1001 with a radiation shield 1002. As can be seen, the radiation shield forms part of the structural assembly by attaching to a bellows section 1004 that allows the combustor to move within the recuperator core in response to changing temperatures. The swirler head 1003 is also shown.

### Other Types of Combustors

Modern gas turbine engines incorporate combustors for reacting pressurized fuel and air to increase turbine inlet temperature. Typically a pressurized fuel source delivers liquid or gaseous fuel to a pre-mixer just upstream of the combustion zone. Alternative designs, as proposed by Dibble (U.S. Pat. No. 6,205,768) and others (Pfefferle U.S. Pat. No. 4,864,811, Mackay U.S. Pat. No. 4,754,607) describe a method whereby gaseous fuel is introduced at the engine's compressor inlet, mixed with air while passing through the compressor and recuperator, and reacted in a catalytic bed upstream of the turbine. The catalyst is a necessary requirement for most gas turbine engines to enable and complete the fuel/air reaction in a reasonable time and volume. However, catalysts are known to be expensive and life limiting in a gas turbine environment. Still other gas turbine combustion inventions by Kesseli (U.S. Pat. No. 6,895,760) introduce volatile organic compounds (VOCs) at the engine's compressor inlet, mix the VOC and air during passage through the engine, then react the mixture on a high temperature matrix, or so-called thermal reactor. The thermal reactor is less expensive than a catalytic bed and has longer life, however this approach works only with high volatility organic compounds, such as propane and heptane.

It is also possible to efficiently react mixtures of fuel and air in a gas turbine engine combustor in a thermal oxidizer reactor. These type of devices achieve ultra low emissions by avoiding high reaction temperatures. The thermal reactor efficiency is dependent upon the reactor bed temperature, the mixture inlet temperature, the stoichiometry, pressure, and residence time. Methane is known to react slowly and require high temperatures in the absence of a catalyst. This strategy of fuel introduction and mixing eliminates the typical fuel pressurization system and associated parasitic losses, cost and complexity. Alternately, fuel may be introduced just ahead of the combustor.

A multi-stage compressor, ceramic first stage turbine, and recuperator create a set of conditions conducive to the design of a thermal reactor. A practical thermal reactor for methane/air requires pressure levels over 5 bar and 1,370 K reaction zone temperature to achieve a compact and economical size with a methane and air, mixture, which is the most difficult, fuel to react in this type of combustor. A thermal reactor designed for a combustor for a gas turbine engine is described in U.S. Provisional Application 61/482,936 entitled “Thermal Reactor Combustion System for a Gas Turbine Engine”, filed on May 5, 2011 which is incorporated herein by reference.

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the inventions can be used. As will be appreciated, it would be possible to provide for some features of the inventions without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter

What is claimed is:

1. An engine, comprising:
a plurality of turbo-compressor spool assemblies, each turbo-compressor spool assembly comprising a compressor and a turbine attached by a common shaft and a first of the turbo-compressor spool assemblies is in fluid communication with a second of the turbo-compressor spool assemblies;
a free power turbine driven by a gas flow output by at least one of the turbo-compressor assemblies;
a recuperator comprising at least two manifolds operable to transfer heat from an exhaust gas from the free power turbine to a pressurized gas to form a further heated gas; and
a combustor operable to combust a fuel and the further heated gas, wherein the combustor is at least partially inserted in one of the at least two manifolds of the recuperator and wherein an output temperature of the combustor gas products is at least about 1,200 degrees Kelvin.

2. The engine of claim 1, wherein the combustor is housed substantially inside of the recuperator, wherein radiant heat from the combustor can damage the recuperator, and further comprising:
a radiation shield positioned between the recuperator and combustor to retard radiant heat from the combustor damaging the recuperator.

3. The engine of claim 1, further comprising a shield positioned between the recuperator and the combustor at least one of to guide the combustor into a selected position within the recuperator and to maintain the combustor in the selected position relative to the recuperator.

4. The engine of claim 1, further comprising a shield positioned between the recuperator and combustor, the shield directing the further heated gas from the recuperator to an inlet of the combustor.

5. The engine of claim 4, wherein a directed flow path of the further heated gas is along a side surface of the combustor and into the inlet, whereby the further heated gas increases a convective heat transfer coefficient by removing, heat from the combustor side surface upstream of the inlet.

6. The engine of claim 5, wherein the side surface extends substantially an entire length of the combustor.

7. The engine of claim 5, wherein the shield directs a first portion of the further heated gas to a swirler head of the combustor, a second portion of the further heated gas to at least one dilution port, and a third portion to at least one combustion liner cooling hole.

8. The engine of claim 5, wherein the shield inlet is configured to block substantially line-of-sight radiation emitted by the combustor.

9. The engine of claim 2, wherein the radiation shield is attached to a bellows section that allows the combustor to move relative to the recuperator core in response to changing temperatures.

10. The engine of claim 2, wherein the radiation shield is reflective to reflect at least a portion of the thermal radiation.

11. The engine of claim 2, wherein the radiation shield adsorbs a substantial portion of the thermal radiation emitted by the combustor towards the recuperator.

12. A method, comprising:
providing a gas turbine engine, the gas turbine engine comprising a turbo-compressor spool assembly, the turbo-compressor spool assembly comprising a compressor and a turbine attached by a common shaft, a free power turbine driven by a gas flow output by the turbo-compressor assembly, a recuperator operable to transfer heat from an exhaust gas from the free power turbine to a pressurized gas to form a further heated gas, and a combustor operable to combust a fuel and the further heated gas, wherein the combustor is at least partially surrounded by the recuperator; and
operating the combustor at a combustor operating temperature of at least about 1,200 degrees Kelvin.

13. The method of claim 12, wherein the combustor is housed substantially inside of the recuperator, wherein radiant heat from the combustor can damage the recuperator, and wherein the gas turbine engine comprises a radiation shield positioned between the recuperator and combustor to retard radiant heat from the combustor damaging the recuperator.

14. The method of claim 12, further comprising a shield positioned between the recuperator and the combustor at least one of to guide the combustor into a selected position within the recuperator and to maintain the combustor in the selected position relative to the recuperator.

15. The method of claim 12, further comprising a shield positioned between the recuperator and combustor, the shield directing the further heated gas from the recuperator to an inlet of the combustor.

16. The method of claim 15, wherein a directed flow path of the further heated gas is along a side surface of the combustor and into the inlet, whereby the further heated gas increasing a convective heat transfer coefficient by removing heat from the combustor side surface upstream of the inlet.

17. The method of claim 16, wherein the side surface extends substantially an entire length of the combustor.

18. The method of claim 16, wherein the shield directs a first portion of the further heated gas to a swirler head of the combustor, a second portion of the further heated gas to at least one dilution port, and a third portion to a combustion liner cooling hole.

19. The method of claim 16, wherein the shield inlet is configured to block substantially line-of-sight radiation emitted by the combustor.

20. The method of claim 17, wherein the radiation shield is attached to a bellows section that allows the combustor to move relative to the recuperator core in response to changing temperatures.

21. The method of claim 13, wherein the radiation shield is reflective to reflect at least a portion of the thermal radiation.

22. The method of claim 13, wherein the radiation shield adsorbs a substantial portion of the thermal radiation emitted by the combustor towards the recuperator.
